(19) United States
(12) Patent Application Publication
(10) Pub. No.: US 2013/0228051 A1
(43) Pub. Date: Sep. 5, 2013

(54) TELESCOPIC HAND TOOL

(71) Applicant: Chin-Tan Huang, Taichung City (TW)

(72) Inventor: Chin-Tan Huang, Taichung City (TW)

(21) Appl. No.: 13/782,884

(22) Filed: Mar. 1, 2013

(30) Foreign Application Priority Data
Mar. 3, 2012 (TW) 101203833

(51) Int. Cl. B25G 1/04

(52) U.S. Cl. CPC B25G 1/04
USPC 81/177.2

(57) ABSTRACT

A telescopic hand tool includes an outer tube, an inner rod and a positioning unit. The outer tube has an inner surface formed with opposite first and second grooves. The inner rod is inserted in and movable relative to the outer tube between retracted and extended positions, and has an outer surface that has a segment confronting the inner surface and formed with a furrow portion. The positioning unit is disposed in the outer tube and includes a positioning block corresponding in position to the furrow portion and a resilient member disposed in the furrow portion for biasing the positioning block toward the inner surface to engage releasably the first and second grooves.

### CROSS-REFERENCE TO RELATED APPLICATION

This application claims priority of Taiwanese Patent Application No. 101203833, filed on Mar. 3, 2012, the disclosure of which is incorporated herein by reference.

### BACKGROUND OF THE INVENTION

1. Field of the Invention

This invention relates to a hand tool, more particularly to a telescopic hand tool.

2. Description of the Related Art

A conventional telescopic hand tool includes a main body, a tubular bar and a positioning device. The main body extends in an axial direction, and includes a tool head and a rod extending from the tool head in the axial direction into the tubular bar.

The positioning device is mounted between the main body and the tubular bar, and includes a cylindrical rotating knob that is sleeved on and fixed to a portion of the tubular bar and a torsion spring that has two ends connected fixedly and respectively to the rotating knob and the portion of the tubular bar. The torsion spring is in tight frictional contact with the rod so as to prevent movement of the rod in the axial direction relative to the tubular bar.

To adjust a length of the conventional telescopic hand tool, the rotating knob is twisted relative to the tubular bar against the biasing force of the torsion spring to expand the torsion spring radially and outwardly so as to release the rod from the frictional contact with the torsion spring, and then the rod can be moved relative to the tubular bar in the axial direction.

However, it is necessary for a user to continuously hold the rotating knob with one hand at the twisted state relative to the tubular bar so that only one hand is left for length adjustment of the telescopic rod. Once the rotating knob is released from twisting, the torsion spring would restore to position the rod immediately. Thus, it is inconvenient to adjust the length of the conventional telescopic rod. Additionally, replacement of the torsion spring is relatively cumbersome.

### SUMMARY OF THE INVENTION

The object of the present invention is to provide a length-adjustable telescopic hand tool that has a relatively simple structure and that can be easily operated.

According to this invention, a telescopic hand tool comprises an outer tube, an inner rod and a positioning unit. The outer tube extends in an axial direction, and has opposite first and second end portions in the axial direction, and an inner surface formed with first and second grooves that are respectively formed at the first and second end portions. The inner rod extends in the axial direction, is inserted in the outer tube, and is movable relative to the outer tube in the axial direction between retracted and extended positions. The inner rod has opposite interior and exterior end portions that are respectively surrounded by and exposed from the outer tube, and an outer surface. The exterior end portion is adapted to be connected to a tool head. The outer surface has a segment at the interior end portion, confronting the inner surface of the outer tube, and formed with a furrow portion. The positioning unit is disposed in the outer tube and includes a positioning block that corresponds in position to the furrow portion of the inner rod, and a resilient member that is disposed in the furrow portion for biasing the positioning block toward the inner surface of the outer tube. The positioning block engages the first groove when the inner rod is at the retracted position, and engages the second groove when the inner rod is at the extended position. The positioning block is biased to be in frictional contact with the inner surface of the outer tube for positioning the inner rod relative to the outer tube when the inner rod is between the retracted and extended positions.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary partly sectional view of a preferred embodiment of a telescopic hand tool according to the present invention, illustrating an inner rod at a retracted position;

FIG. 2 is a sectional view taken along line II-II in FIG. 1;

FIG. 3 is a fragmentary partly sectional view of the preferred embodiment, illustrating the inner rod being moved relative to an outer tube of the telescopic hand tool;

FIG. 4 is a sectional view taken along line IV-IV in FIG. 3;

FIG. 5 is a fragmentary exploded perspective view of a positioning unit of the preferred embodiment; and

FIG. 6 is a sectional view of the preferred embodiment, illustrating the inner rod at an extended position.

### DETAILED DESCRIPTION OF THE PREFERRED EMBODIMENT

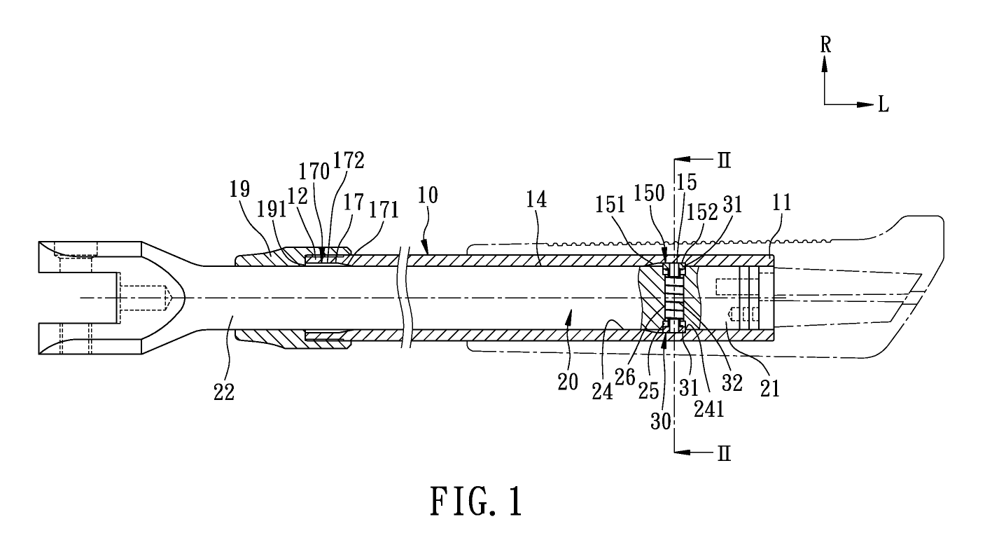

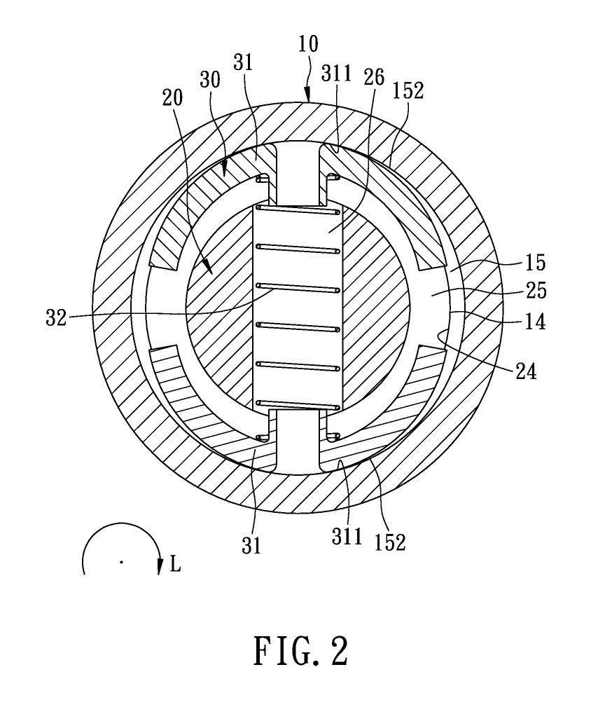

Referring to FIGS. 1 and 2, the preferred embodiment of a telescopic hand tool according to the present invention is shown to include an outer tube 10, an inner rod 20, and a positioning unit 30.

The outer tube 10 extends in an axial direction (L), and has opposite first and second end portions 11, 12 in the axial direction (L), and an inner surface 14 formed with first and second grooves 15, 17 that are respectively formed at the first and second end portions 11, 12.

The first groove 15 is defined by a first groove defining surface 150 that has first and second annular surface sections 151, 152. The first annular surface section 151 is disposed between the second groove 17 and the second annular surface section 152 and converges toward the second end portion 12. The second groove 17 is defined by a second groove defining surface 170 that has first and second annular surface sections 171, 172. The first annular surface section 171 is disposed between the first groove 15 and the second annular surface section 172 of the second groove defining surface 170 and converges toward the first end portion 11.

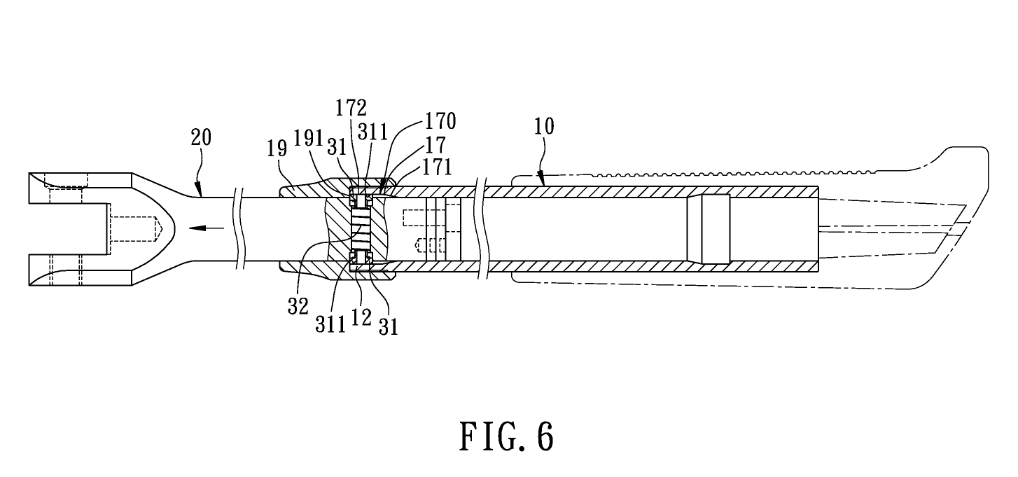

The inner rod 20 extends in the axial direction (L), is inserted in the outer tube 10, and is movable relative to the outer tube 10 in the axial direction (L) between a retracted position (see FIG. 1) and an extended position (see FIG. 6). The inner rod 20 has an outer surface 24 and opposite interior and exterior end portions 21, 22 that are respectively surrounded by and exposed from the outer tube 10. The exterior end portion 22 is connected to a tool head. The outer surface 24 of the inner rod 20 has a segment 241 at the interior end portion 21, confronting the inner surface 14 of the outer tube 10, and formed with a furrow portion 25.

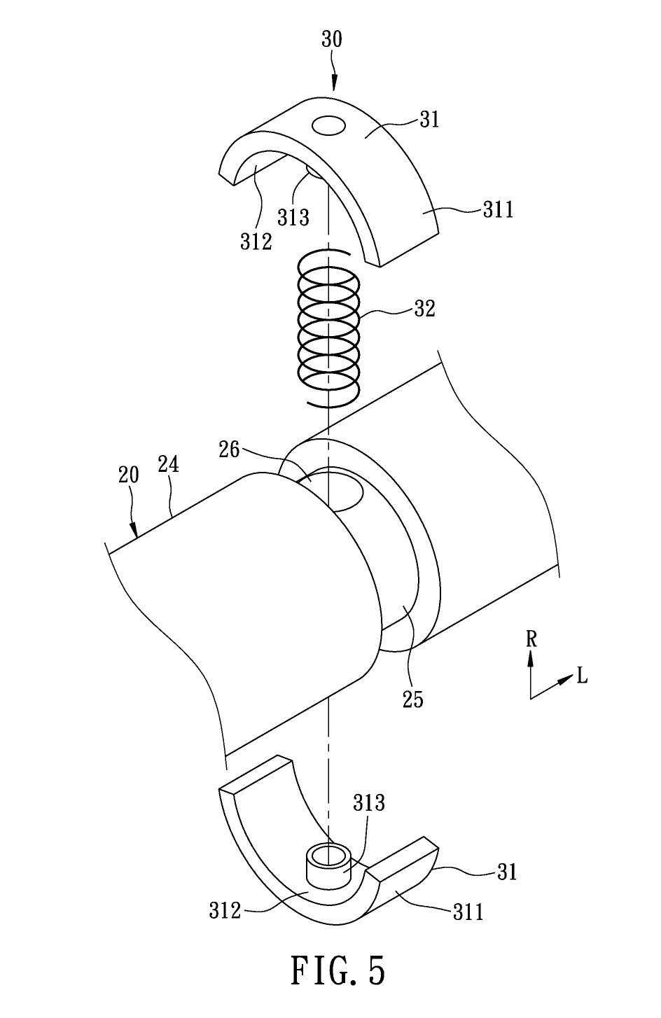

In this embodiment, the positioning unit 30 is disposed in the outer tube 10 and includes two positioning blocks 31 and a resilient member 32. Further referring to FIG. 5, the inner rod 20 is formed with a through hole 26 that extends in a direction (R) perpendicular to the axial direction (L) and that extends through the furrow portion 25. The positioning blocks 31 correspond in position to the furrow portion 25 of the inner rod 20. Each of the positioning blocks 31 has a semi-circular block body that has an outer face 311 confronting the inner surface 14 of the outer tube 10 and an inner face 312 radially opposite to the outer face 311, and a projection 313 that projects from the inner face 312. In this embodiment, the resilient member 32 is a compression spring that extends through the through hole 26 of the inner rod 20 and that has opposite ends connected respectively to the projections 313 of the positioning blocks 31 for biasing the positioning blocks 31 toward the inner surface 14 of the outer tube 10.

As illustrated in FIGS. 1 and 2, when the inner rod 20 is at the retracted position, the positioning blocks 31 are biased by the resilient member 32 to engage the first groove 15. At this time, the outer faces 311 of the positioning blocks 31 abut against the first groove defining surface 150 so as to position the inner rod 20 stably relative to the outer tube 10.

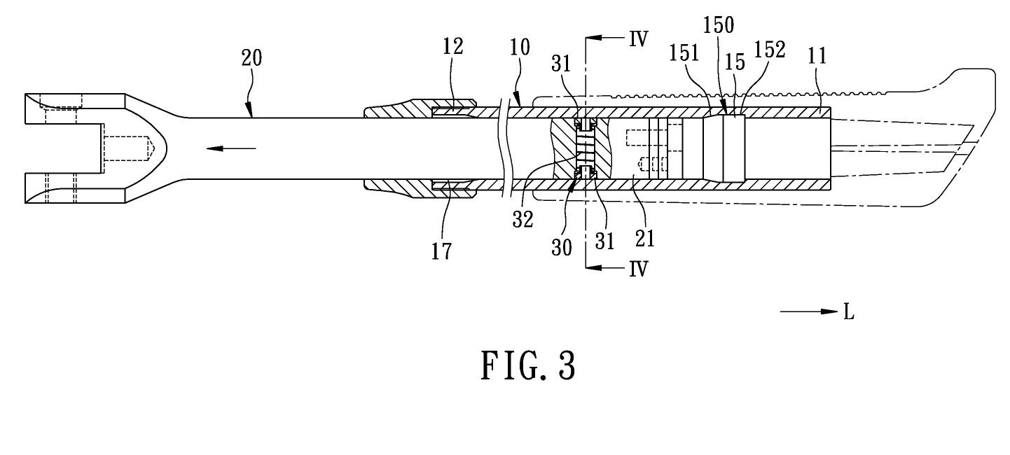

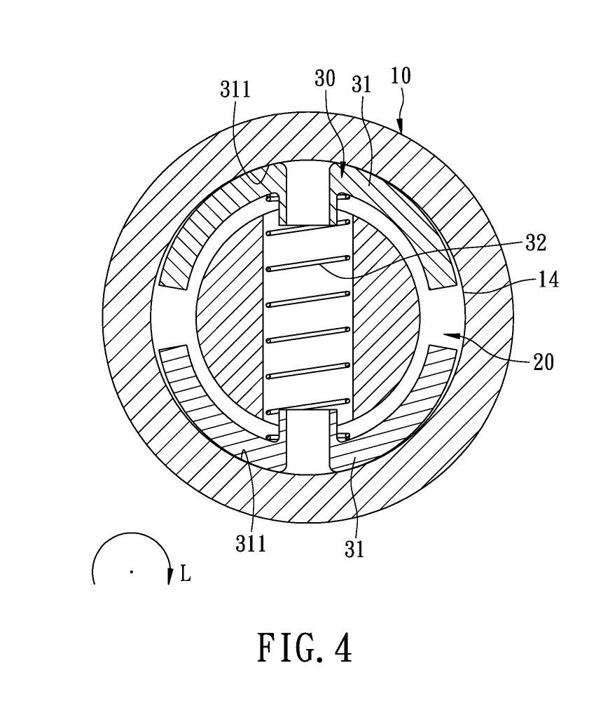

Referring to FIGS. 3 and 4, in order to adjust a length of the telescopic rod, the inner rod 20 is moved from the retracted position toward the extended position in the axial direction (L). The positioning blocks 31 are driven to be disengaged from the first groove 15 against a biasing force of the resilient member 32 to enable the interior end portion 21 of the inner rod 20 to move toward the second end portion 12 of the outer tube 10. The inclined first annular surface section 151 of the first groove defining surface 150 facilitates disengagement of the positioning blocks 31 from the first groove 15. When a force exerted on the inner rod 20 is released, the resilient member 32 is compressed and the positioning blocks 31 are biased by a restoring force of the resilient member 32 to be in frictional contact with the inner surface 14 of the outer tube 10 for positioning the inner rod 20 relative to the outer tube 10 at a desired position between the retracted and extended positions. It should be noted that static friction between the outer faces 311 of the positioning blocks 31 and the inner surface 14 is sufficient to provide resistance to the movement of the inner rod 20 relative to the outer tube 10 in the axial direction (L) when no external force is exerted on the inner rod 20 and the outer tube 10.

Referring to FIG. 6, when the inner rod 20 is further moved toward the second end portion 12 to the extended position, the positioning blocks 31 are driven to slide over the first annular surface section 171 of the second groove defining surface 170 and are biased by the restoring force of the resilient member 32 to engage the second groove 17. At this time, the outer faces 311 of the positioning blocks 31 abut against the second groove defining surface 170 so as to position the inner rod 20 stably relative to the outer tube 10. The inclined second annular surface section 171 of the second groove defining surface 170 facilitates disengagement of the positioning blocks 31 from the second groove 17 in the next length-adjustment action of the preferred embodiment.

Additionally, in this embodiment, the second end portion 12 of the outer tube 10 terminates at an end of the second annular surface section 172 of the second groove defining surface 170. The outer tube 10 further includes a cap 19 sleeved on a portion of the second end portion 12 of the outer tube 10 and cooperating with the second end portion 12 to define a shoulder portion 191 (see FIG. 6) that abuts against the positioning blocks 31 so as to prevent removal of the inner rod 20 from the outer tube 10 when the inner rod 20 is at the extended position.

When it is desired to replace the resilient member 32, the cap 19 is first removed from the outer tube 10, and the inner rod 20 together with the positioning unit 30 are pulled out of the outer tube 10 so that the resilient member 32 can be accessed for replacement.

To sum up, by virtue of the first and second grooves 15, 17, the inner rod 20 can be stably positioned relative to the outer tube 10 at the retracted and extended positions. Further, the configuration of the annular surface sections 151, 171 facilitates smooth length adjustment of the telescopic hand tool by moving the inner rod 20 relative to the outer tube 10 in the axial direction (L). Finally, it is convenient to replace the resilient member 32.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A telescopic hand tool comprising:
an outer tube extending in an axial direction, and having opposite first and second end portions in the axial direction, and an inner surface formed with first and second grooves that are respectively formed at said first and second end portions;
an inner rod extending in the axial direction, inserted in said outer tube, movable relative to said outer tube in the axial direction between retracted and extended positions, and having
opposite interior and exterior end portions that are respectively surrounded by and exposed from said outer tube, said exterior end portion being adapted to be connected to a tool head, and
an outer surface that has a segment at said interior end portion, confronting said inner surface of said outer tube, and formed with a furrow portion; and
a positioning unit disposed in said outer tube and including a positioning block that corresponds in position to said furrow portion of said inner rod, and a resilient member that is disposed in said furrow portion for biasing said positioning block toward said inner surface of said outer tube;
wherein said positioning block engages said first groove when said inner rod is at the retracted position, and said positioning block engages said second groove when said inner rod is at the extended position, said positioning block being biased to be in frictional contact with said inner surface of said outer tube for positioning said inner rod relative to said outer tube when said inner rod is between the retracted and extended positions.

2. The telescopic hand tool as claimed in claim 1, wherein said first groove is defined by a first groove defining surface that has first and second annular surface sections, said first annular surface section being disposed between said second groove and said second annular surface section and converging toward said second end portion.

3. The telescopic hand tool as claimed in claim 2, wherein said second groove is defined by a second groove defining surface that has first and second annular surface sections, said first annular surface section of said second groove defining surface being disposed between said first groove and said second annular surface section of said second groove defining surface and converging toward said first end portion.

4. The telescopic hand tool as claimed in claim 1, wherein:
said positioning unit includes two of said positioning blocks;
said inner rod is formed with a through hole that extends in a direction perpendicular to the axial direction and that extends through said furrow portion; and
said biasing member is a compression spring extending through said through hole and having opposite ends connected respectively to said positioning blocks.

5. The telescopic hand tool as claimed in claim 4, wherein each of said positioning blocks has a semi-circular block body that has an outer face confronting said inner surface of said outer tube and an inner face opposite to said outer face, and a projection that projects from said inner face and that is connected fixedly to a respective one of said opposite ends of said biasing member.
